(19) United States
(12) Patent Application Publication
(10) Pub. No.: US 2026/0133329 A1
(43) Pub. Date: May 14, 2026

(54) DOUBLE LIGHT OUTPUT SCINTILLATION STRUCTURE FOR SCINTIGRAPHIC INVESTIGATIONS

(71) Applicant: CONSIGLIO NAZIONALE DELLE RICERCHE, ROME (IT)

(72) Inventors: Alessandro SOLURI, Rome (IT); Roberto MASSARI, NETTUNO (RM) (IT)

(21) Appl. No.: 19/119,262

(22) PCT Filed: Sep. 28, 2023
(86) PCT No.: PCT/IB2023/059681

§ 371 Date: Apr. 8, 2025

(30) Foreign Application Priority Data
Oct. 21, 2022 (IT) 102022000021738

(51) Int. Cl. G01T 1/29; G01T 1/202

(52) U.S. Cl. CPC G01T 1/2985; G01T 1/202

(57) ABSTRACT

Described is a measuring structure (100) for PET or SPECT applications comprising a matrix of scintillation crystals (200) each having a bar shape and extending along a longitudinal axis (X). Wherein the scintillation crystals (200) are parallel to each other and oriented in such a way as to define a measuring direction (R) that is transversal to the longitudinal axis (X). The measuring structure (100) comprises a first electronic conversion circuitry associated with the first surface (200a) of each scintillation crystal (200) for receiving an optical signal and converting it into an electric signal and a second electronic conversion circuitry associated with the second surface (200b) of each scintillation crystal (200) for receiving an optical signal and converting it into an electric signal. The scintillation crystals (200) are separated from each other by at least first sheets (300a) perpendicular to the measuring direction (R) and made of a metal material with a high atomic number designed to screen the incident radiations having energy that is lower than a predetermined threshold.

This invention relates to a measuring structure of the type present in diagnostic imaging devices for PET or SPECT analyses used for locating lymph nodes, tumours and/or other diseases.

Currently, a radiopharmaceutical is administered to a patient in order to locate diseases such as those listed above. The radiopharmaceutical tends to bind with the pathogenic cells defining a bio-distribution that can be displayed by measurement devices.

As is known, the imaging devices use the conversion of the energy of the photons of the incident radiation into light in such a way that the latter can be “collected” by electronic devices such as, for example, photodiodes or phototubes.

The prior art imaging devices are substantially formed by a scintillation structure (that is to say, by a single large crystal or a plurality of scintillation crystals), one or more photomultiplicators and, if necessary, a collimator (in the case of SPECT techniques).

In more detail, the photomultiplicator is connected to the scintillation structure by means of a suitable optical connection and its purpose is to detect the luminous photons of the incident radiation transforming them into an electrical signal which is amplified and carried towards the processing circuits to recreate the image of the radiation source, that is to say, of the zone affected by disease.

The photomultiplicator is normally associated with the entire surface of the scintillation structure.

The collimator, on the other hand, if present, is positioned between the source which emits radiation and the scintillation structure and has the purpose of allowing the passage of only the radiation directed perpendicularly to the scintillation structure, screening all the radiation directed in different directions.

In order to improve the intrinsic spatial resolution of the imaging devices, measuring structures have been developed which comprise a plurality of scintillation crystals positioned side by side to form a matrix of crystals.

There are prior art matrix structures, that is to say, structures wherein individual bar-shaped crystals are coated with epoxy resins, the purpose of which is to keep the crystals equidistant and able to converge the light from the outlet face towards the photomultiplicator. In this situation, the radiation emitted strikes the volume of the scintillation crystal on the upper part most in contact with the collimator whilst the other coated faces convey the light produced towards the photomultiplicator (in such a way as to obtain, by processing the signals collected, an image relative to the bio-distribution of the radiopharmaceutical).

In fact, during PET or SPECT type analyses, the radiopharmaceutical emits radiation in different directions, some of which intercept the crystals causing an impact of the photons on them at respective scintillation points.

In this situation, Compton diffusion events in the crystal can be produced, which can generate multiple interaction between nearby crystals and which, in turn, can contribute to an incorrect reconstruction of the position of the interaction event. In general, the fact that one or more photons produce scintillation points between adjacent crystals with respect to the first interaction results in a potential error in the calculation of the position of the interaction of the photon and thus obtaining a more degraded image in the final information (signal-noise ratio).

Also in the case of PET applications, the Compton event between crystals can determine an incorrect calculation of the position of first interaction thereby falsifying the counting statistics as well as the final image of the zone affected by disease.

In other words, a problem particularly felt is that relative to the Compton effects which arise between nearby crystals contributing to a distribution of false events on the image obtained. Another element which affects the noise of the scintigraphic images may be determined by the Compton events which may be produced inside the body, due to the interaction of the photons emitted which encounter surrounding tissue. These photons, degraded in energy, can reach the detector and be recorded as total events.

More specifically, in the case of SPECT applications with emissions of single photons, this aspect is largely resolved with the use of collimators which filter the passage of the angled photons which come from the body but, disadvantageously, they cannot prevent the passage of those photons which pass through the holes of the collimator after having undergone scattering inside the body and which arrive at right angles on the detector. These events, having an energy less than the incident energy, can be eliminated only if they are outside the energy window selected for forming the image.

The technical purpose of the invention is therefore to provide a measuring structure which is able to overcome the drawbacks of the prior art.

The aim of the invention is therefore to provide a measuring structure which has a better spatial resolution.

A further aim of the invention is to provide a measuring structure which can be used both for the SPECT and for the PET techniques.

A further aim of the invention is to provide a measuring structure which is able to improve the diagnostic performance in terms of contrast of the images and, in general, optimise the diagnostic information.

A further aim of the invention is to provide a measuring structure which is able to limit events which are not useful for forming the image thus contributing to the exclusive selection of the events valid for forming the scintigraphic image.

The technical purpose indicated and the aims specified are substantially achieved by a measuring structure comprising the technical features described in one or more of the accompanying claims. The dependent claims correspond to possible embodiments of the invention.

Further features and advantages of the invention are more apparent in the non-limiting description which follows of a non-exclusive embodiment of a measuring structure.

The description is set out below with reference to the accompanying drawings which are provided solely for purposes of illustration without restricting the scope of the invention and in which:

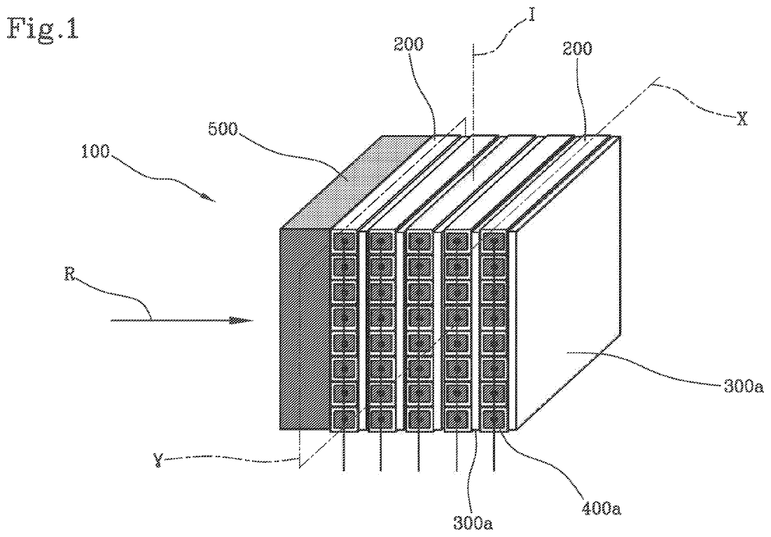

FIG. 1 is a perspective view of a measuring structure according to the invention;

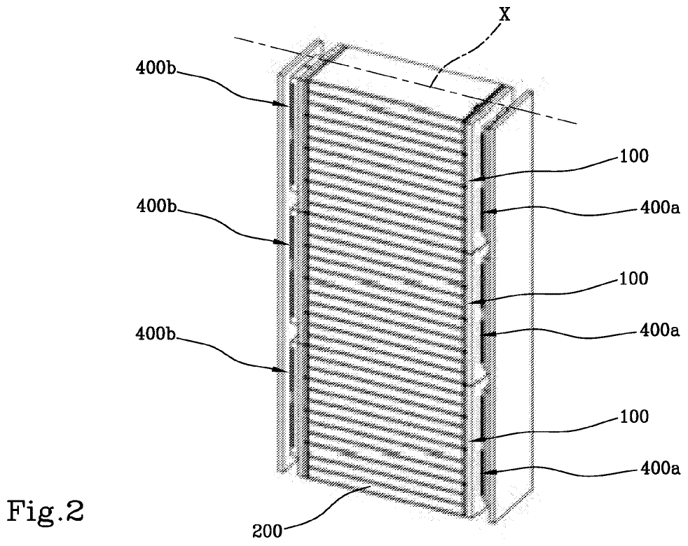

FIG. 2 is a perspective view of several assembled measuring structures;

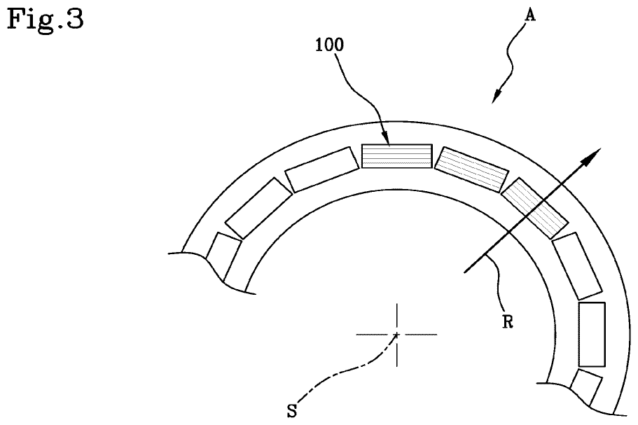

FIG. 3 shows a cross section view of a PET measuring ring.

With reference to the accompanying drawings, the numeral 100 denotes a measuring structure for PET or SPECT applications.

The measuring structure 100 comprises a matrix of scintillation crystals 200 configured for simultaneously measuring radiation coming from a zone of the body suitably stressed by means of a radiopharmaceutical.

According to a possible embodiment, the scintillation crystals 200 of the matrix are non-hygroscopic crystals such as, for example: LYSO, LSO, GSO and the like.

Alternatively, the scintillation crystals 200 of the matrix are hygroscopic crystals such as, for example: Sodium iodide (NaI(Tl)), lanthanum chloride (LaCl3:Ce) and lanthanum bromide (LaBr3:Ce) and the like.

As shown in the accompanying drawings, each scintillation crystal 200 has the shape of a bar, that is to say, substantially parallelepiped. In this situation, each scintillation crystal 200 has two faces perpendicular to the longitudinal axis “X” and defining, respectively, the first and the second surface of the output of light of the crystals, whilst the remaining faces of the bar define a lateral peripheral surface extending parallel to the longitudinal axis “X” useful for conveying the light towards the output faces. Each scintillation crystal 200 extends along a longitudinal axis “X”, between two surfaces with light output faces which are opposite each other.

According to the embodiment illustrated, the scintillation crystals 200 have, in cross section, a substantially square shape with respect to the longitudinal axis X. Alternatively, each scintillation crystal 200 has, in cross section, a substantially rectangular shape.

Preferably, each scintillation crystal 200 has a constant cross section along the longitudinal axis “X”, that is to say, each scintillation crystal 200 does not have a variation of the area along the longitudinal axis “X”.

Preferably, the cross-section of the scintillation crystals 200 is between 1 mm ² and 30 mm ² and more preferably between 5 mm ² and 20 mm ² .

As shown in the embodiment of the accompanying drawings, the dimension of each scintillation crystal 200 along the longitudinal axis “X” is greater than the corresponding transversal dimension.

According to an aspect of the invention, each scintillation crystal 200 comprises a length, measured along the longitudinal axis “X”, preferably between 2 cm and 15 cm.

As shown in FIG. 1, the scintillation crystals 200 are parallel to each other and oriented in such a way as to define a measuring direction “R” that is transversal, preferably perpendicular, to the longitudinal axis “X”.

In more detail, the scintillation crystals 200 are moved towards each other in such a way that the lateral peripheral surfaces of a scintillation crystal 200 are adjacent to respective lateral peripheral surfaces of the nearby scintillation crystals 200 in such a way as to form a matrix.

The matrix is organised in such a way that, on each plane γ perpendicular to the measuring direction “R” there is a series of scintillation crystals 200 stacked on top of each other in such a way that the longitudinal axes “X” are perpendicular to the measuring direction “R” and lie on the plane γ.

In more detail, the scintillation crystals 200 lying on a same plane γ are stacked along a stacking direction “I” perpendicular to the measuring direction “R” and to the longitudinal axes “X” in such a way as to form a “layer” of scintillation crystals 200.

By way of example, in FIG. 1 there are five planes γ (only one of them is indicated in the drawing) each perpendicular to the measuring direction “R” and having, stacked on each other along the stacking direction “I”, eight scintillation crystals 200.

As shown in the accompanying drawings, the measuring structure 100 also comprises first sheets 300a perpendicular to the measuring direction “R” and made of a metal material with a high atomic number designed to screen the incident radiations having energy that is lower than a predetermined threshold.

The first sheets 300a are configured for separating from each other the scintillation crystals 200.

The first sheets 300a are parallel to the planes γ defined by the scintillation crystals 200 and are interposed between one plane γ and the other in such a way as to act as dividing elements for the layers of scintillation crystals 200.

As shown in FIG. 1, the first sheets 300a divide the matrix of scintillation crystals 200 into “layers” transversal to the measuring direction “R” and each formed by the same number of scintillation crystals 200.

In this situation, the first sheets 300a define, for the layers of scintillation crystals 200, screens of the incident radiation, the screening effect of which is added along the measuring direction “R”.

With reference for example to FIG. 1, at the moment of absorbing the incident radiation, the layer of scintillation crystals 200 further to the left will have the greater energy level (since it is the first to be struck by the radiation) whilst the layer of scintillation crystals 200 further to the right will have the lower energy level since, during the passage from one layer of scintillation crystals 200 to another, the first sheets 300a progressively absorb the radiation.

Preferably, the first sheets 300a are made of metal material, for example tungsten or tungsten or platinum alloys, with a high atomic number, more suitable for slowing high energies which can absorb external events from the energy window selected for forming the image. For example, having fixed a window for selecting the events in energy, between 400 keV and 600 keV, the sheets 300a are designed to absorb energy events of less than 400 keV. The layers after the first must not necessarily comprise the same thicknesses as the previous materials and may be partly replaced by materials with a lower Z. This is because interactions may occur in the absorbent material which induce fluorescence, which can be absorbed by means of these layers.

As shown in FIG. 1, the measuring structure 100 is formed by a plurality of scintillation crystals 200 with the shape of a bar and assembled together in such a way as to define a plurality of layers perpendicular to the measuring direction “R”. Each layer is formed by a series of scintillation crystals 200 stacked along the stacking direction “I” and is separated from the adjacent layer by the interposition of a first sheet 300a of the plurality.

According to the preferred embodiment, the scintillation crystals 200 are also separated from each other by an optically reflective material, for example a resin. In particular, the scintillation crystals 200 are separated from each other by a coating directly applied to the scintillation crystal 200.

Preferably, this optical coating covers entirely the longitudinal surfaces of each scintillation crystal 200. In this situation, each scintillation crystal 200 has the light output faces clear of any coating.

As shown in FIG. 1, the scintillation crystals 200 belonging to the same layer are separated from one another, along the stacking direction “I”, thanks to the presence of the reflective material applied to the lateral surface of each scintillation crystal 200.

Again with reference to FIG. 1, each first layer 300a is interposed between the reflective optical coating of the scintillation crystals 200 of a layer and that of the layer of the scintillation crystals 200 adjacent to it.

In use, therefore, the scintillation crystals 200 are coated, on their lateral surfaces, with the reflective material and are positioned in such a way as to form respective layers of scintillation crystals 200.

In more detail, each layer has the scintillation crystals 200 stacked on top of each other along the stacking direction “I” with the longitudinal axes “X” parallel to each other. In this situation, each scintillation crystal 200 is separated from the scintillation crystal 200 and from the one below along the stacking direction “I” by the respective layers of reflective material.

The various layers are then moved towards each other in such a way that a first sheet 300a is interposed between one layer and another. The distance between the various layers may be variable and not fixed.

The measuring structure 100 assembled in this way is struck by the radiation incident along the measuring direction “R” transversal to the longitudinal axes “X”. In this situation, it is the peripheral lateral surface of the scintillation crystals 200 that is exposed to the radiation whilst the faces free from each screen act as output faces for the radiation.

The measuring structure 100 comprises a first electronic conversion circuitry 400a associated with the first surface of each scintillation crystal 200 for receiving an optical signal and converting it into an electrical signal.

The measuring structure 100 comprises a second electronic conversion circuitry 400b associated with the second surface of each scintillation crystal 200 for receiving an optical signal and converting it into an electrical signal.

In other words, the first and the second surface of each scintillation crystal 200 are associated, respectively, with the first and the second electronic conversion circuitry 400a, 400b in such a way that two optical signals are received simultaneously and are converted into respective electrical signals.

In particular, the first and second electronic conversion circuitries 400a, 400b are synchronised with each other to perform a simultaneous conversion of the respective optical signals.

By way of a non-limiting example, the first and the second electronic conversion circuitries 400a, 400b may be achieved in the form of photodiodes, SiPM or MPPC.

Advantageously, unlike the prior art wherein a single scintillation crystal is coupled to an electronic device which must necessarily record all the information deriving from the interaction of the radiation incident with the scintillation crystal, the distribution in layers of the scintillation crystals 200 allows discrete information to be recorded on how the energy is deposited in each scintillation crystal 200 as a function of its probability of interaction with the incident radiation.

According to an aspect of the invention, the scintillation crystals 200 may also be separated from each other by second sheets (not illustrated) perpendicular to the first sheets 300a and made of metal material with a high atomic number designed to screen the incident radiation having energy less than a predetermined threshold. Preferably, the first sheets 300a and the second sheets are integrated in a single monolithic grid structure, also with elements of different sizes from each other.

Alternatively, the first sheets 300a and the second sheets are reversibly engageable to each other to form the above-mentioned grid.

As shown in FIG. 1, the structure 100 also comprises at least one filter 500 applied to a lateral face of the matrix of scintillation crystals 200 perpendicularly to the measuring direction “R” and configured to absorb the radiation having energy of lower than a predetermined value.

Preferably, the filter 500 is applied on the lateral face of the matrix facing towards the radiation.

The filter 500 is of the multilayer type and, preferably, at least one layer is made of a metallic material, whilst at least one layer is made of a material with a low density.

More preferably, the metallic material is selected between: copper, tungsten, gadolinium, yttrium, aluminium lead, bismuth, tin and brass.

When the radiation strikes the measuring structure 100, in the case of an occurrence of Compton events coming from the body and directed on the measuring structure 100, this event can potentially distort the signal acquired for forming the image relative to the bio-distribution.

By using the filter 500 it is, on the other hand, possible to clean the signal of non-useful contributions for the formation of the image in such a way as to information with a greater contrast both in SPECT and PET techniques.

According to an aspect of the invention, the matrix of scintillation crystals 200 comprises a two-dimensional distribution of crystals where the number of crystals along a first dimension is between 3 and 10 and the number of crystals along the second direction is between 20 and 100 (as shown, for example, in FIG. 2).

This allows the analysis of any areas affected by larger sized pathology.

In this regard, thanks to the placing alongside each other of several scintillation crystals 200 in a two-dimensional structure such as that shown in FIG. 2, it is possible to increase the limit on the dimensions of the investigation zone.

In other words, by assembling, along the longitudinal axis “X”, several scintillation structures 100 it is possible to make up larger structures which are able to scan a zone affected by a pathology having larger dimensions.

The use of several assembled scintillation structures 100 is particularly advantageous especially in the PET detection rings “A” since it allows particularly precise images to be obtained without excessively increasing the dimensions of the entire ring “A”.

In this situation, the PET measuring ring “A” comprises a plurality of measuring structures 100 distributed angularly about an axis of symmetry “S” of the ring “A”.

As shown in FIG. 3, each measuring structure 100 is made as described above. Preferably, the number of measuring structures 100 is between 20 and 100 and, more preferably, between 40 and 50.

The invention achieves the preset aims eliminating the drawbacks of the prior art. In particular, the presence of the double electronic conversion circuitry in conjunction with the distribution of the scintillation crystals makes it possible to improve the diagnostic performance in terms of contrast of the images and, in general, optimise the diagnostic information.

The measuring structure, according to the invention, is able to limit events which are not useful for forming the image thus contributing to the exclusive selection of the events valid for forming the scintigraphic image.

1. A measuring structure (100) for PET or SPECT applications comprising:
a matrix of scintillation crystals (200), each scintillation crystal (200) having the shape of a bar and extending along a longitudinal axis (X) between a first surface and a second surface opposite the first surface, the dimension of each scintillation crystal (200) along the axis (X) being greater than the corresponding transversal dimension, wherein the scintillation crystals (200) are parallel to each other and oriented in such a way as to define a measuring direction (R) transversal, preferably perpendicular, to said longitudinal axis (X);
a first electronic conversion circuitry (400a) associated with the first surface of each scintillation crystal (200) for receiving an optical signal and converting it into an electrical signal;
a second electronic conversion circuitry (400b) associated with the second surface of each scintillation crystal (200) for receiving an optical signal and converting it into an electrical signal; wherein the scintillation crystals (200) are separated from each other by at least first sheets (300a) perpendicular to said measuring direction (R) and made of a metal material with a high atomic number designed to screen the incident radiations having energy that is lower than a predetermined threshold.

2. The structure according to claim 1, wherein the scintillation crystals (200) are separated from each other also by second plates perpendicular to said first plates (300a) and made of a metal material having a high atomic number suited to shield incident radiations having energy that is lower than a predetermined threshold, said first plates (300a) and second plates preferably being integrated in a single monolithic grid-shaped structure.

3. The structure according to claim 1, wherein the scintillation crystals (200) are also separated from each other by an optically reflective barrier, in particular a coating directly applied to the crystal; preferably, said barrier entirely covering the lateral peripheral surface of each scintillation crystal (200).

4. The structure according to claim 1, wherein each scintillation crystal (200) has a length, measured along the longitudinal axis (X), of between 3 cm and 20 cm.

5. The structure according to claim 1, wherein the cross section of said scintillation crystals (200) is between 1 mm and 30 mm, preferably between 5 mm² and 20 mm².

6. The structure according to claim 1, wherein the structure (100) comprises at least one filter (500) applied to a lateral face of the matrix of scintillation crystals (200) perpendicularly to the measuring direction and configured to absorb the radiation having energy of lower than a predetermined value.

7. The structure according to claim 6, wherein said filter (500) is of the multilayer type, said filter (500) preferably being a multilayer wherein at least one layer is made of a metallic material and at least one layer is made of a low density material, said metallic material preferably being selected from among: copper, tungsten, gadolinium, yttrium, lead aluminium, bismuth, tin and brass.

8. The structure according to claim 1, wherein said first and second electronic conversion circuitries (400a, 400b) are synchronised with each other to perform a simultaneous conversion of the respective optical signals.

9. The structure according to claim 1, wherein said matrix of scintillation crystals (200) comprises a two-dimensional distribution of scintillation crystals, wherein the number of scintillation crystals along a first dimension is between 3 and 10 and the number of scintillation crystals along the second direction is between 20 and 100.

10. A PET measuring ring (A), comprising a plurality of measuring structures (100) distributed angularly about an axis of symmetry(S) of the ring (A), wherein each measuring structure (100) is made according to claim 1, preferably said measuring structures (100) being between 20 and 100, more preferably between 40 and 50.
